(19) United States
(12) Patent Application Publication
(10) Pub. No.: US 2025/0103935 A1
(43) Pub. Date: Mar. 27, 2025

(54) QUANTUM COMPUTING ELEMENT FREQUENCY SHIFTING

(71) Applicant: IQM FINLAND OY, Espoo (FI)

(72) Inventor: Pasi LÄHTEENMÄKI, Espoo (FI)

(21) Appl. No.: 18/730,179

(22) PCT Filed: Jan. 25, 2022
(86) PCT No.: PCT/FI2022/050048

§ 371 Date: Jul. 18, 2024

(51) Int. Cl. G06N 10/40

(52) U.S. Cl. CPC G06N 10/40

(57) ABSTRACT

According to an embodiment, an arrangement for quantum computing element frequency shifting comprises: a plurality of persistent current loops, each persistent current loop being couplable to a corresponding quantum computing element; a first plurality of signal lines, wherein each persistent current loop is coupled to a corresponding signal line in the first plurality of signal lines; and a second plurality of signal lines, wherein each persistent current loop is coupled to a corresponding signal line in the second plurality of signal lines; wherein each persistent current loop is configured to induce a persistent current in the persistent current loop in response to a pulse in a corresponding signal line in the first plurality of signal lines and/or in a corresponding signal line in the second plurality of signal lines, wherein the persistent current is configured to cause a shift in a frequency of the corresponding quantum computing element.

### TECHNICAL FIELD

The present disclosure relates to a quantum computing, and more particularly to an arrangement for quantum computing element frequency shifting and a quantum computing system.

### BACKGROUND

As the number of qubits grows, the requirements for fine tuning the per qubit direct current (DC) fluxes require an increasing number of cables and equipment that contribute to the complexity and cost of the system in several ways. DC wires can also introduce low frequency noise that can limit the coherence times of the qubits and causes drift. One option would be to focus on DC source design. However, controlling, for example, 2500 qubits or couplers is a complex task no matter the kind of DC sources available. Mechanical or semiconductor switches at various temperature stages can be utilized, but they all have disadvantages.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective to provide an arrangement for quantum computing element frequency shifting and a quantum computing system. The foregoing and other objectives are achieved by the features of the independent claims. Further implementation forms are apparent from the dependent claims, the description and the figures.

According to a first aspect an arrangement for quantum computing element frequency shifting comprises: a plurality of persistent current loops, each persistent current loop comprising at least one Josephson junction, at least one shunt resistive element, and at least one inductive element and each persistent current loop being couplable to a corresponding quantum computing element; a first plurality of signal lines, wherein each persistent current loop in the plurality of persistent current loops is coupled to a corresponding signal line in the first plurality of signal lines; and a second plurality of signal lines, wherein each persistent current loop in the plurality of persistent current loops is coupled to a corresponding signal line in the second plurality of signal lines; wherein each persistent current loop in the plurality of persistent current loops is configured to induce a persistent current in the persistent current loop in response to a pulse in a corresponding signal line in the first plurality of signal lines and/or in a corresponding signal line in the second plurality of signal lines, wherein the persistent current is configured to cause a shift in a frequency of the corresponding quantum computing element. The arrangement can, for example, shift the frequency of the quantum computing element with a reduced number of signal lines and/or signal sources required.

In an implementation form of the first aspect, each persistent current loop in the plurality of persistent current loops is electrically coupled to the corresponding signal line in the first plurality of signal lines and to the corresponding signal line in the second plurality of signal lines, and is configured to induce the persistent current in the persistent current loop in response to an electrical current between the corresponding signal line in the first plurality of signal lines and the corresponding signal line in the second plurality of signal lines through the at least one Josephson junction exceeding a critical current of the at least one Josephson junction. The arrangement can, for example, shift the frequency of the quantum computing element with a reduced number of signal lines and/or signal sources required.

In another implementation form of the first aspect, each persistent current loop is electrically coupled to the corresponding signal line in the first plurality of signal lines via at least one first coupling resistive element and/or at least one first coupling inductive element and wherein each persistent current loop is coupled to the corresponding signal line in the second plurality of signal lines via at least one second coupling resistive element and/or at least one second coupling inductive element. The coupling resistive elements and/or the coupling inductive elements can, for example, limit reverse current flow to non-addressed persistent current loops.

In another implementation form of the first aspect, each persistent current loop in the plurality of persistent current loops is inductively coupled to the corresponding signal line in the first plurality of signal lines and to the corresponding signal line in the second plurality of signal lines, and is configured to induce the persistent current in the persistent current loop in response to a first pulse in the corresponding signal line in the first plurality of signal lines and a second pulse in the corresponding signal line in the second plurality of signal lines when a total induced current by the first pulse and the second pulse in the persistent current loop is greater than a critical current of the at least one Josephson junction of the persistent current loop. The arrangement can, for example, shift the frequency of the quantum computing element with a reduced number of signal lines and/or signal sources required.

In another implementation form of the first aspect, each persistent current loop in the plurality of persistent current loops is inductively couplable to the corresponding quantum computing element and is configured to cause the shift in the frequency of the corresponding quantum computing element via a magnetic field induced by the persistent current. The arrangement can, for example, efficiently shift the frequency of the corresponding quantum computing element via the magnetic field induced by the persistent current.

In another implementation form of the first aspect, each quantum computing element comprises at least one Josephson junction, and wherein the magnetic field is configured to adjust a Josephson inductance of the at least one Josephson junction of the corresponding quantum computing element. The arrangement can, for example, efficiently shift the frequency of the corresponding quantum computing element via adjusting the Josephson inductance of the at least one Josephson junction of the corresponding quantum computing element.

In another implementation form of the first aspect, each quantum computing element comprises a qubit or a coupler between qubits.

According to a second aspect, a quantum computing system comprises a plurality of qubits and an arrangement according to the first aspect, wherein at least one persistent current loop in the plurality of persistent current loops of the arrangement is coupled to a corresponding qubit in the plurality of qubits. The arrangement can, for example, fine-tune frequencies of the qubits via the persistent current. Thus, continuous external current is not needed for the fine-tuning.

In an implementation form of the second aspect, the quantum computing system further comprises a plurality of couplers, wherein each coupler is coupled to two qubits in the plurality of qubits and configured to control coupling between the two qubits, and wherein at least one persistent current loop in the plurality of persistent current loops of the arrangement is coupled to a corresponding coupler in the plurality of couplers. The arrangement can, for example, fine-tune frequencies of the couplers via the persistent current. Thus, continuous external current is not needed for the fine-tuning.

In another implementation form of the second aspect, each qubit in the plurality of qubits comprises at least one Josephson junction and/or wherein each coupler in the plurality of couplers comprises at least one Josephson junction.

In another implementation form of the second aspect, the plurality of qubits comprises superconductive qubits.

In another implementation form of the second aspect, the quantum computing system further comprises a control unit coupled to the first plurality of signal lines and the second plurality of signal lines of the arrangement and configured to shift a frequency of a target qubit in the plurality of qubits by providing a pulse to a signal line in the first plurality of signal lines corresponding to the target qubit and/or to a signal line in the second plurality of signal lines corresponding to the target qubit. The system can, for example, efficiently fine-tune the frequency of the target qubit.

Many of the attendant features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIG. 1 illustrates a schematic representation of an arrangement for quantum computing element frequency shifting according to an embodiment;

FIG. 2 illustrates a schematic representation of an arrangement for quantum computing element frequency shifting according to another embodiment;

FIG. 3 illustrates a schematic representation of an arrangement for quantum computing element frequency shifting according to another embodiment;

FIG. 4 illustrates a schematic representation of coupling between a persistent current loop and a quantum computing element according to an embodiment;

FIG. 5 illustrates a plot representation of a simulation of currents in different persistent current loops according to an embodiment;

FIG. 6 illustrates a plot representation of a simulation of current flowing in the Josephson junction of each persistent current loop;

FIG. 7 illustrates a plot representation of a simulation of current flowing in the resistive element of each persistent current loop;

FIG. 8 illustrates a plot representation of a simulation of current flowing in the persistent current loops for different pulse lengths;

FIG. 9 illustrates a plot representation of a simulation of current flowing in the resistive element of an addressed persistent current loop;

FIG. 10 illustrates a plot representation of a simulation of current flowing in the persistent current loops when persistent current is added and removed from one persistent current loop;

FIG. 11 illustrates a schematic representation of a quantum computing system 1100 according to an embodiment; and

FIG. 12 illustrates a schematic representation of a control unit according to an embodiment.

In the following, like reference numerals are used to designate like parts in the accompanying drawings.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, there-fore, is not to be taken in a limiting sense, as the scope of the present disclosure is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

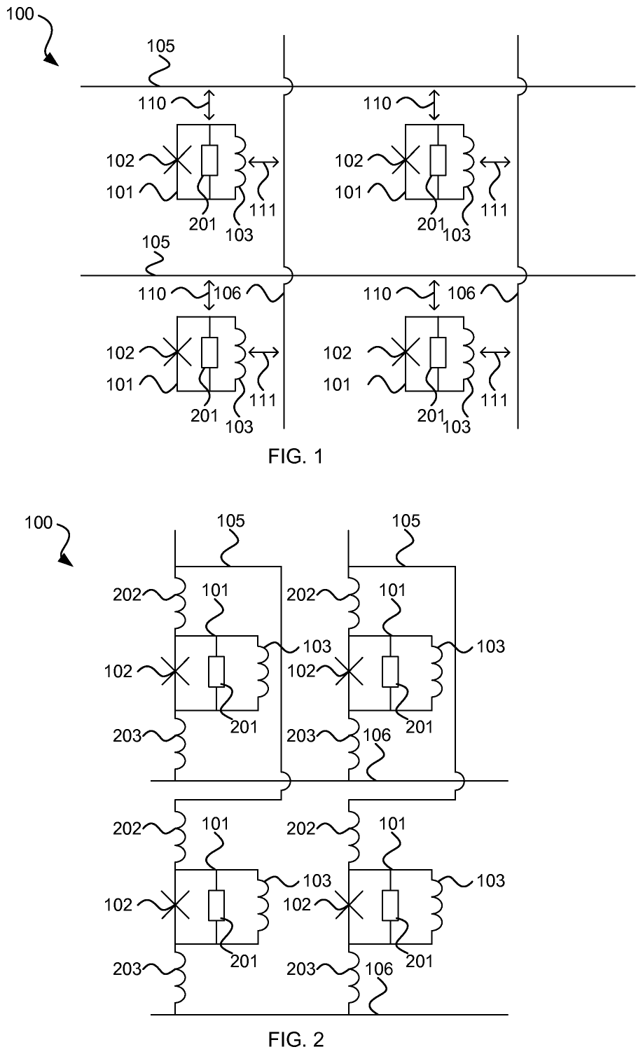

FIG. 1 illustrates a schematic representation of an arrangement 100 for quantum computing element frequency shifting according to an embodiment.

According to an embodiment, an arrangement 100 for quantum computing element frequency shifting comprises a plurality of persistent current loops, each persistent current loop 101 comprising at least one Josephson junction 102, at least one shunt resistive element 201, and at least one inductive element 103 and each persistent current loop 101 being couplable to a corresponding quantum computing element.

The quantum computing element may comprise, for example, a qubit or a coupler between qubits.

The arrangement 100 may further comprise a first plurality of signal lines 105, wherein each persistent current loop 101 in the plurality of persistent current loops is coupled 110 to a corresponding signal line in the first plurality of signal lines 105.

Each persistent current loop 101 may be electromagnetically coupled 110 to the corresponding signal line in the first plurality of signal lines 105. For example, each persistent current loop may be Galvanically coupled to the corresponding signal line in the first plurality of signal lines 105. Thus, there may be electrical current flow from the corresponding signal line to the persistent current loop. Alternatively, each persistent current loop may be inductively and/or capacitively coupled to the corresponding signal line in the first plurality of signal lines 105. Thus, there may be electromagnetic interaction between the persistent current loop and the signal line without electrical current flow between them.

The arrangement 100 may further comprise a second plurality of signal lines 106, wherein each persistent current loop 101 in the plurality of persistent current loops is coupled 111 to a corresponding signal line in the second plurality of signal lines 106.

Each persistent current loop 101 may be electromagnetically coupled 111 to the corresponding signal line in the second plurality of signal lines 106. For example, each persistent current loop may be Galvanically coupled to the corresponding signal line in the second plurality of signal lines 106. Thus, there may be electrical current flow from the corresponding signal line to the persistent current loop. Alternatively, each persistent current loop may be inductively and/or capacitively coupled to the corresponding signal line in the second plurality of signal lines 106. Thus, there may be electromagnetic interaction between the persistent current loop and the signal line without electrical current flow between them.

The first plurality of signals lines 105 and the second plurality of signal lines 106 may form a matrix. The first plurality of signal lines 105 may correspond to rows of the matrix and the second plurality of signal lines 106 may correspond to columns of the matrix, or vice versa.

Each persistent current loop 101 in the plurality of persistent current loops may be configured to induce a persistent current in the persistent current loop 101 in response to a pulse in a corresponding signal line in the first plurality of signal lines 105 and/or in a corresponding signal line in the second plurality of signal lines 106, wherein the persistent current is configured to cause a shift in a frequency of the corresponding quantum computing element.

Each persistent current loop 101 may be couplable to the corresponding quantum computing element in various ways. For example, each persistent current loop 101 may be electrically connected to an inductive element for coupling the persistent current loop to a quantum computing element. The inductive element may be configured to shift in a frequency of the corresponding quantum computing element by causing a magnetic flux through the quantum computing element.

Each persistent current loop can be addressed by driving a pulse into a corresponding signal line in the first plurality of signal lines 105 and/or the second plurality of signal lines. The persistent current loop into which the persistent current is added may be referred to as an addressed persistent current loop, a target persistent current loop, or similar. Other signal lines in the first plurality of signal lines 105 and/or in the second plurality of signal lines 106 can be, for example, in a floating state during the addressing. When a signal line is in a floating state, there may be no electrical connection via which an electrical current could flow. Thus, persistent current is only added into the addressed persistent current loop.

Herein, a persistent current may refer to an effect whereby biasing a shunted Josephson junction above its critical current allows persistent current to accumulate in the persistent current loop 101. A shunted Josephson junction refers to the fact that the persistent current loop comprises the shunt resistive element 201. The shunt resistive element 201 may also be referred to as a shunt resistor or similar. The shunt resistive element 201 can allow transients to stabilize in the persistent current loop 101. Thus the shunt resistive element 201 can allow the persistent current loop 101 to controllably accumulate persistent current for a steady state in the inductive element 103 and the Josephson junction 102 even though current does not flow through the shunt resistive element 201 in steady state.

The persistent current can be added into each persistent current loop 101 in discrete flux quanta due to the magnetic flux through the persistent current loop 101 being quantised.

Accumulation of flux quanta can also be seen as analogous to phase particle running across potential hills in the Josephson junction 102 washboard potential. The shunt resistive element 201 serves to damp the system once it has “kicked” over the potential hill (by the pulse) in order to allow the phase particle to stop at the bottom of the next valley before running across the next (undesired) hill of the washboard potential.

The signal lines may be implemented, for example, as traces on a printed circuit board (PCB), as traces on a silicon chip, as cables, as transmission lines, as waveguides, or similar. The signal lines may comprise superconductive signal lines.

Quantum computing units, (QPUs) typically require that each qubit and coupler between qubits is fine-tuned using a high fidelity direct current (DC) bias during a calibration phase. The fine-tuning can, for example, compensate for manufacturing differences between the qubits and/or couplers. The bias currents can be provided by, for example, programmable low-noise DC sources. For example, for a 1000 qubit QPU, this amounts to approximately 2500 DC wires and corresponding number of low-drift DC sources at room temperature. Cost and complexity of operating 2500 high-fidelity programmable DC sources per a QPU can require significant infrastructure. Moreover, if the QPU is located in a cryostat, a large number of DC wiring down to the cryostat may also be required. Continuous current may also be needed during the operation of the QPU to maintain the fine-tuning.

The arrangement 100 can set persistent current on a per quantum computing element basis using an external current source to supply the initial persistent current. The arrangement 100 can be implemented on, for example, the QPU chip itself or as a stacked auxiliary chip capable of operating at the cryostat temperatures in persistent state without power consumption due to the persistent current. Thus, the arrangement 100 may also not contribute to the thermal load of the cryostat. External current can be disconnected and thus noise originating from room temperature sources may not affect the QPU. A single high-fidelity external DC source can be used sequentially to set the persistent current for any number of qubits and couplers.

The arrangement 100 may require two sets of sqrt (N) signal lines for N quantum computing elements. Thus, for a 2500 computing element chip, 50+50 lines from room temperature may be needed. At room temperature a simple switch matrix can be used to set all of the 2500 persistent currents by utilizing just one or two current sources.

The arrangement 100 may fine-tune the frequency of, for example, each qubit and coupler of a QPU during a calibration stage. A continuous fine-tuning current is not needed during the operation of the QPU due to the persistent currents in the persistent current loops 101.

If needed due to limits of flux quantization, inductance can be added to a persistent current loop using a Josephson junction, several Josephson junctions in series or several parallel persistent current loops with varying coupling for additive effect. Josephson inductance can be made relatively large in comparison to geometric inductance. Maximum number of flux quanta one can place in a persistent current loop is proportional to the total loop inductance (for a given shunted Josephson junction critical current), thus the larger the loop inductance, the more possible persistent current levels one has available and as such it becomes easier to have a wider range of tuning.

FIG. 2 illustrates a schematic representation of an arrangement for quantum computing element frequency shifting according to another embodiment.

According to an embodiment, each persistent current loop 101 in the plurality of persistent current loops is electrically coupled to the corresponding signal line in the first plurality of signal lines 105 and to the corresponding signal line in the second plurality of signal lines 106, and is configured to induce the persistent current in the persistent current loop in response to an electrical current between the corresponding signal line in the first plurality of signal lines 105 and the corresponding signal line in the second plurality of signal lines 106 through the at least one Josephson junction 102 exceeding a critical current of the at least one Josephson junction 102.

In the embodiment of FIG. 2, each persistent current loop comprises a Josephson junction 102 that is shunted using a shunt resistive element 201. The shunted Josephson junction 101 and the at least one inductive element 103 form the persistent current loop 101. The shunt resistive element 201 can allow the persistent current loop to acquire flux quanta in a controllable manner during biasing, since the shunt resistive element 201 acts to damp oscillations. The shunt resistive element 201 does not play a role once persistent current has been established in the persistent current loop 101, i.e. there is no voltage across the shunt resistive element 201 and no current flows through the shunt resistive element 201 in a steady state. Instead, current only flows through the Josephson junction 101 and the at least one inductive element 103.

For example, the electrical current may be caused by the pulse in a corresponding signal line in the first plurality of signal lines 105 and the current caused by the pulse flowing into the corresponding signal line in the second plurality of signal lines 106 via the addressed persistent current loop or vice versa.

Neither current nor voltage are exactly constant during the pulse as the signal lines are coupled to the persistent current loops and their dynamics. A low impedance voltage source can feed the pulse to the signal lines with certain impedance with real and imaginary components and this results in current running in the superconducting signal wires which have some response to the internal dynamics of the persistent current loops. The current in the superconducting signal wires is set by the impedance of the feed lines, part of the that impedance is real. However, if the superconducting lines are weakly coupled to the current loops one can consider an approximately constant current pulse whose value is set by the other impedances in the system. The feedline likely has some filtering and some resistors before the superconducting lines on the chip.

When the critical current of the at least one Josephson junction 102 is exceeded, flux quanta is added into the persistent current loop 101.

The electrically coupling may comprise, for example, a Galvanic coupling or any other type of coupling that allows current to flow between the corresponding signal line in the first plurality of signal lines 105 and the corresponding signal line in the second plurality of signal lines 106 through the at least one Josephson junction 102.

Each persistent current loop may be addressed by driving a pulse to the corresponding signal line in the first plurality of signal lines 105 and allowing the current to flow to the corresponding signal line in the second plurality of signal lines 106 via the addressed persistent current loop. Other signal lines in the first plurality of signal lines 105 and/or in the second plurality of signal lines 106 may be in a floating state. Thus, current can flow from the corresponding signal line in the first plurality of signal lines 105 to the corresponding signal line in the second plurality of signal lines 106 through the persistent current loop. The current flow can cause a persistent current in the persistent current loop.

According to an embodiment, each persistent current loop 101 is electrically coupled to the corresponding signal line in the first plurality of signal lines 105 via at least one first coupling resistive element and/or at least one first coupling inductive element 202 and each persistent current loop 101 is coupled to the corresponding signal line in the second plurality of signal lines 106 via at least one second coupling resistive element and/or at least one second coupling inductive element 203.

The coupling inductive elements 202, 203 and/or coupling resistive elements play a different role from the shunt resistive element 201. Where the shunt resistive element 201 damps the Josephson oscillations in that particular loop, coupling inductive elements 202, 203 and/or coupling resistive elements prioritize a particular current path by modifying the circuit dynamic and allowing current to accumulate only in one persistent current loop instead of several. When using vertical-horizonal grid addressing without floating loops, there are several weaker paths for the current which could, without these elements, also cause other loops to accumulate persistent current. The coupling inductive elements 202, 203 and/or coupling resistive elements cause the undesired currents to remain below the accumulation threshold. The resulting steady state is such that current is only added into the addressed persistent current loop even though some current can also exist in other loops during pulsing.

The coupling resistive elements and/or the coupling inductive elements 202, 203 can limit reverse current flow to non-addressed persistent current loops and give priority to the addressed persistent current loop preventing addition of flux quanta into other loops. Without the coupling resistive elements and/or the coupling inductive elements 202, 203, some quanta can end up in non-addressed persistent current loops as well. Furthermore, the coupling resistive elements can lead to a stabilizing system.

For example, in the embodiment of FIG. 2, each persistent current loop 101 is electrically coupled to the corresponding signal line in the first plurality of signal lines 105 via a first coupling inductive element 202 and to the corresponding signal line in the second plurality of signal lines 106 via a second coupling inductive element 203.

In other embodiments, the first coupling inductive element 202 may be replaced by a first coupling resistive element and the second coupling inductive element 203 may be replaced by a second coupling resistive element.

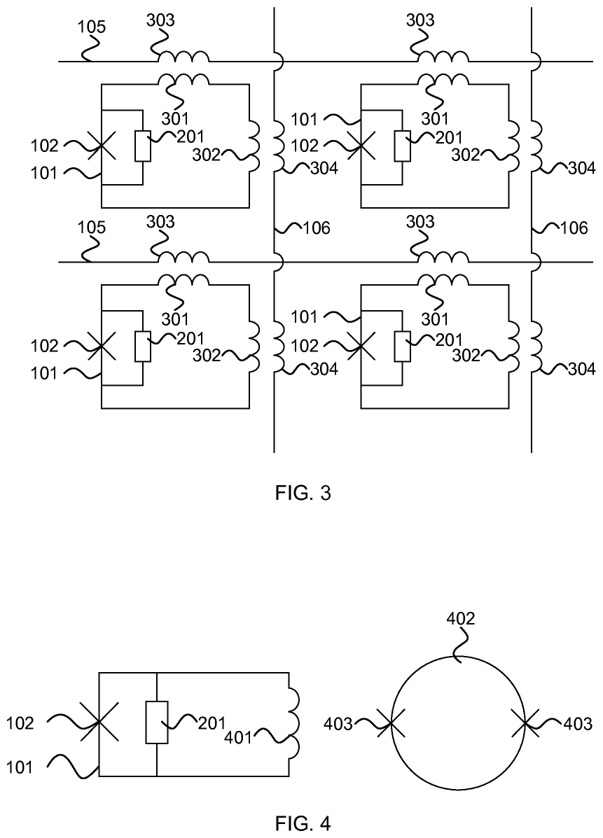

FIG. 3 illustrates a schematic representation of an arrangement for quantum computing element frequency shifting according to another embodiment.

According to an embodiment, each persistent current loop 101 in the plurality of persistent current loops is inductively coupled to the corresponding signal line in the first plurality of signal lines 105 and to the corresponding signal line in the second plurality of signal lines 106, and is configured to induce the persistent current in the persistent current loop 101 in response to a first pulse in the corresponding signal line in the first plurality of signal lines 105 and a second pulse in the corresponding signal line in the second plurality of signal lines 106 when a total induced current by the first pulse and the second pulse in the persistent current loop is greater than a critical current of the at least one Josephson junction 102 of the persistent current loop 101.

For example, in the embodiment of FIG. 3 each persistent current loop comprises a first inductive element 301 and a second inductive element 302, each signal line in the first plurality of signal lines 105 comprises a third inductive element 303, and each signal line in the second plurality of signal lines 106 comprises a fourth inductive element 304. The first inductive element 301 may be inductively coupled to the third inductive element 303 and the second inductive element 302 may be inductively coupled to the fourth inductive element 304. The first 301 and/or the second inductive element 304 may correspond to the at least one inductive element 103.

In the embodiment of FIG. 3, the persistent current loop comprises a Josephson junction 102 and a shunt resistive element 201. This may also be referred to as a shunted RF superconducting quantum interference device (SQUID).

The additive effect of the first pulse and the second pulse on the persistent current loop 101 can add or subtract flux quantum at will from the addressed persistent current loop while leaving the quanta in the non-addressed persistent current loops untouched. The amplitude of a single pulse can be set to a suitable value below the critical current of the Josephson junction 102, but such that two pulses add up to a value above the critical current.

FIG. 4 illustrates a schematic representation of coupling between a persistent current loop and a quantum computing element according to an embodiment.

According to an embodiment, each persistent current loop 101 in the plurality of persistent current loops is inductively couplable to the corresponding quantum computing element 402 and is configured to cause the shift in the frequency of the corresponding quantum computing element 402 via a magnetic field induced by the persistent current.

For example, in the embodiment of FIG. 4, the persistent current loop 101 is electrically coupled to an inductive element 401. The inductive element 401 may correspond to the at least one inductive element 103. The inductive element 401 may be configured to cause the shift in the frequency of the corresponding quantum computing element 402 via a magnetic field induced by the persistent current in the inductive element 401.

According to an embodiment, each quantum computing element 402 comprises at least one Josephson junction 403, and the magnetic field is configured to adjust a Josephson inductance of the at least one Josephson junction 403 of the corresponding quantum computing element 402.

For example, in the embodiment of FIG. 4, the quantum computing element 402 comprises two Josephson junctions 403 forming a SQUID. A SQUID may comprise two Josephson junctions connected in a loop. Such a loop may also be referred to as a SQUID loop. A SQUID can function, for example, as a qubit or as a coupler between qubits.

In some embodiments, the arrangement 100 can be implemented on a separate chip from the quantum computing elements 402. The inductive elements 401 may be implemented on the same chip with the quantum computing element 402 and each inductive element 401 can be electrically coupled to a persistent current loop 101 on the other chip.

Although some embodiments may be disclosed herein with reference to a certain type of qubit, these qubit types are only exemplarily. In any embodiment disclosed herein, the qubits may be implemented in various ways and using various technologies.

Herein, any qubit may comprise, for example, a flux qubit, a phase qubit, and/or a transmon qubit. Different types of qubits can be made to possess the Josephson inductance tuning functionality with simple circuit modifications.

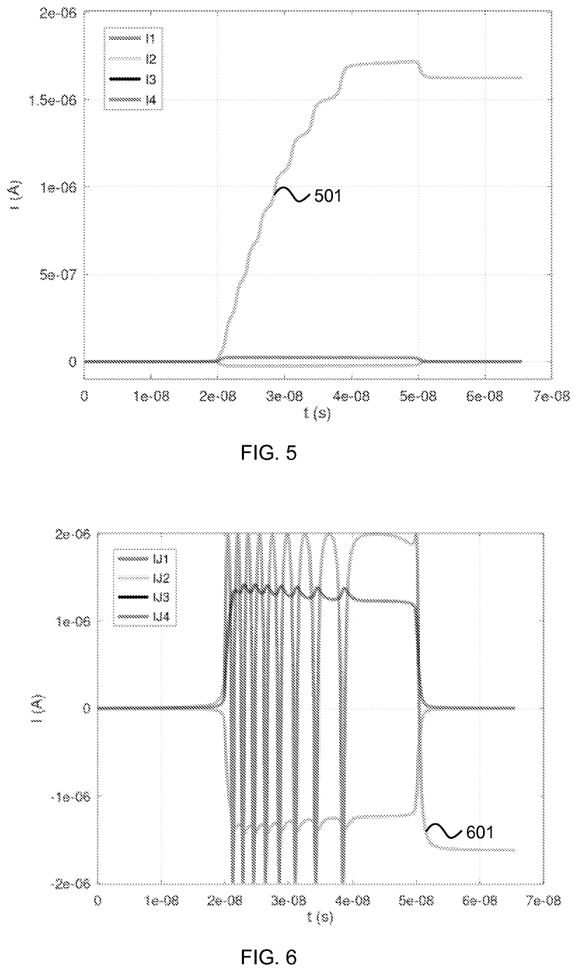

FIG. 5 illustrates a plot representation of a simulation of currents in different persistent current loops according to an embodiment.

In the embodiment of FIG. 5, the curves represent the current in different persistent current loops in an arrangement 100 similar to that presented in the embodiment of FIG. 2. Curve 501 corresponds to the current in the target persistent current loop while the other curves represent the current in other persistent current loops.

In the simulations disclosed herein, the RCSJ model is used for the Josephson junctions. The realized current in the superconducting signal lines during pulsing is not illustrated as this is less relevant as long as the current in the persistent current loops behaves in a desirable manner. The simulations were done by considering the pulse source as 50 ohm and on-chip superconducting lines as either pure weakly coupled inductances or 0-ohm wires depending on the case.

Initially, the external current and persistent current is zero. All columns and rows are open. Then, an external current is pulsed through one persistent current loop from t=20 ns to t=50 ns, other signal lines are kept open. During this period, a persistent current accumulates one flux quanta at a time. After the pulse, the external current can be disconnected. A reverse pulse can be used to remove quanta from a persistent current loop.

It should be appreciated that any parameters values, such as time scales, are only exemplary and may vary based on the design of the arrangement 100.

FIG. 6 illustrates a plot representation of a simulation of current flowing in the Josephson junction of each persistent current loop.

In the embodiment of FIG. 6, the curves represent the current flowing in the Josephson junctions of different persistent current loops in an arrangement 100 similar to that presented in the embodiment of FIG. 2. Curve 601 corresponds to the current in the Josephson junction of the addressed persistent current loop. Each oscillation corresponds to a quantum of flux being added into the addressed persistent current loop. After t=50 ns, a persistent current can be observed in curve 601.

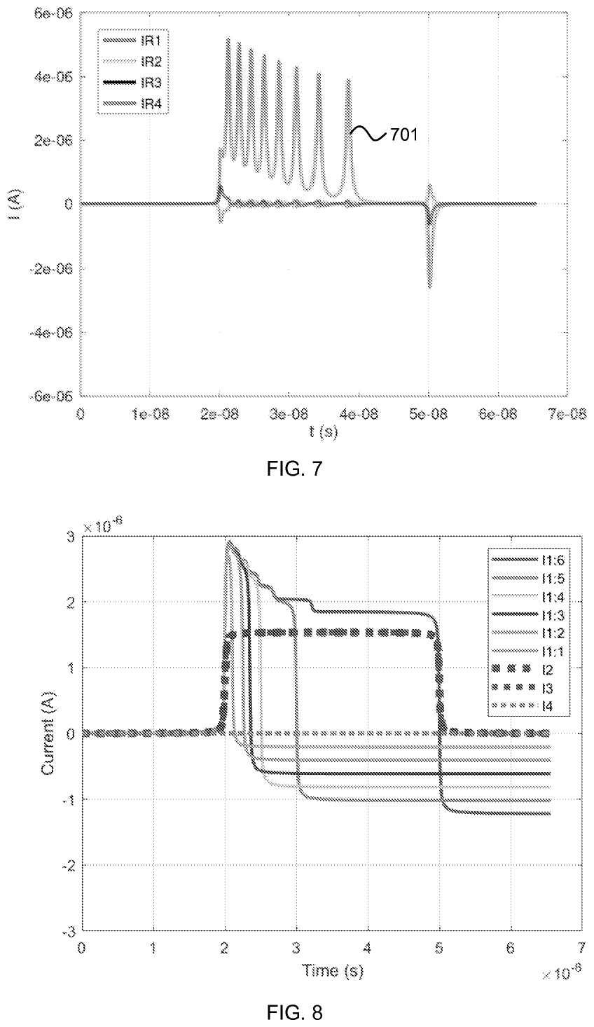

FIG. 7 illustrates a plot representation of a simulation of current flowing in the resistive element of each persistent current loop.

In the embodiment of FIG. 7, the curves represent the current flowing in the resistive elements of different persistent current loops in an arrangement 100 similar to that presented in the embodiment of FIG. 2. Curve 701 corresponds to the current in the resistive element of the addressed persistent current loop. Each peak corresponds to quantum of flux being added into the addressed persistent current loop. After t=50 ns, when no more flux quanta are being added into the addressed persistent current loop, no current flows through the resistive element as can be observed from curve 701.

FIG. 8 illustrates a plot representation of a simulation of current flowing in the persistent current loops for different pulse lengths.

In the embodiment of FIG. 8, the curves represent the current in different persistent current loops in an arrangement 100 similar to that presented in the embodiment of FIG. 3. Solid curves represent the current in the addressed persistent current loop for different pulse lengths while dotted curves represent current in non-addressed persistent current loops.

Initially the currents are zero. Then, flux pulses are provided by external sources through one signal line in the first plurality of signal lines 105 and one signal line in the second plurality of signal lines 106, intersecting at the addressed persistent current loop. As can be seen from FIG. 8, the pulse length affects how many persistent flux quanta are added into the addressed persistent current loop. The persistent current can be observed in FIG. 8 as the current remaining in the steady state after the pulsing. There is no persistent current in the non-addressed persistent current loops.

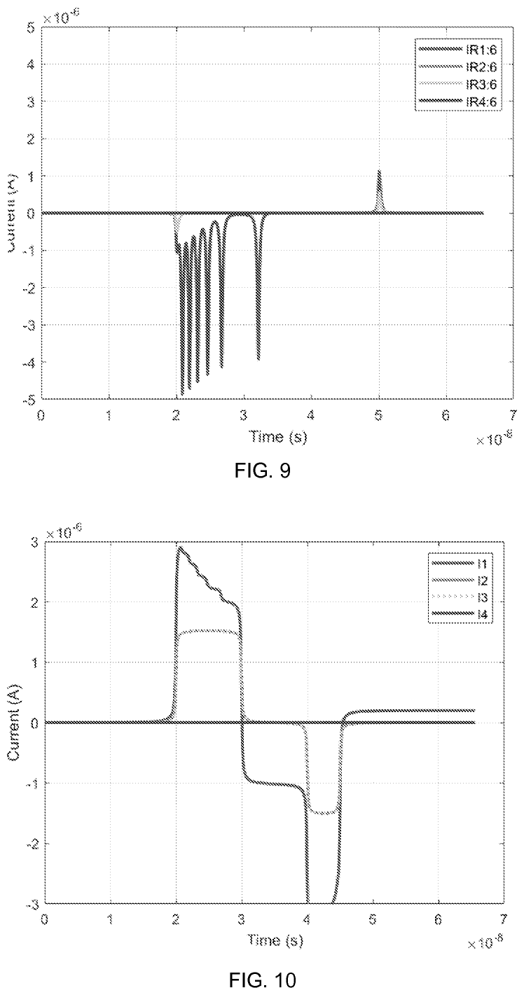

FIG. 9 illustrates a plot representation of a simulation of current flowing in the resistive element of an addressed persistent current loop.

In the embodiment of FIG. 9, the curves represent the current in the resistive element of the addressed persistent current loop for different pulse lengths in an arrangement 100 similar to that presented in the embodiment of FIG. 3. As can be seen from FIG. 9, power is dissipated by the resistive element only during the transitions before the persistent current loop reaches a steady state.

FIG. 10 illustrates a plot representation of a simulation of current flowing in the persistent current loops when persistent current is added and removed from one persistent current loop.

In the embodiment of FIG. 10, persistent current is added to an addressed persistent current loop via pulses from t=20 ns to t=30 ns. After the pulses, a persistent current can be observed in the addressed persistent current loop as a negative persistent current between t=30 ns and t=40 ns while there is no persistent current in non-addressed persistent current loops. From t=40 ns to t=45 ns, pulses of opposing polarity are used to remove persistent current from the addressed persistent current loop. The resulting reduced persistent current can be observer after the pulses while, again, there is no persistent current in the non-addressed persistent current loops.

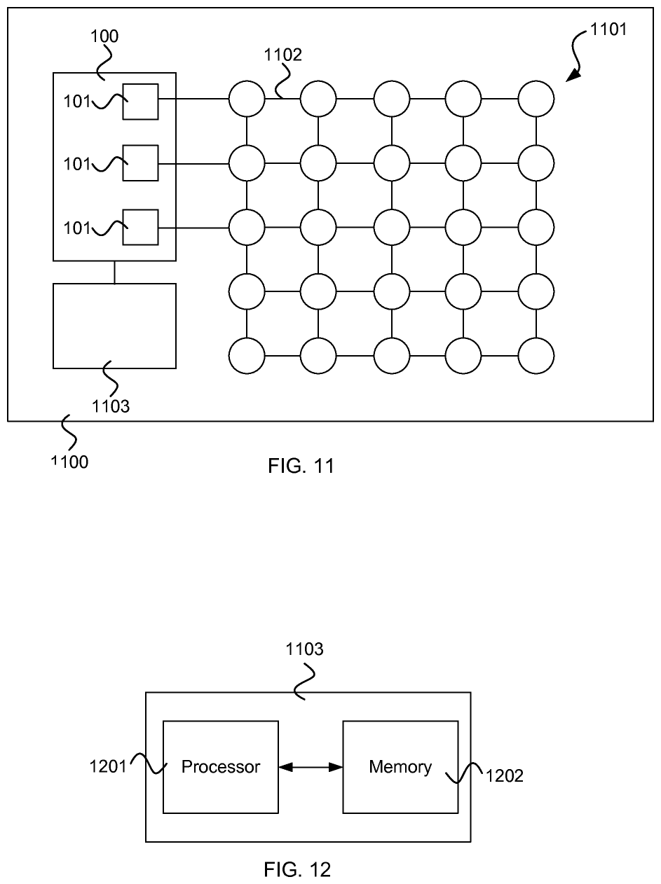

FIG. 11 illustrates a schematic representation of a quantum computing system 1100 according to an embodiment.

According to an embodiment, a quantum computing system 1100 comprises a plurality of qubits 1101 and the arrangement 100. At least one persistent current loop 101 in the plurality of persistent current loops of the arrangement 100 is coupled to a corresponding qubit in the plurality of qubits 1101.

In some embodiments, each persistent current loop 101 in the plurality of persistent current loops of the arrangement 100 may be coupled to a corresponding qubit in the plurality of qubits 1101.

In the embodiment of FIG. 11, three persistent current loops 101 are illustrated in the arrangement 100. Each illustrated persistent current loop 101 is coupled to a corresponding qubit in the plurality of qubits 1101.

According to an embodiment, the quantum computing system 1100 further comprises a plurality of couplers 1102, wherein each coupler is coupled to two qubits in the plurality of qubits 1101 and configured to control coupling between the two qubits, and wherein at least one persistent current loop in the plurality of persistent current loops of the arrangement 100 is coupled to a corresponding coupler in the plurality of couplers 1102.

In some embodiments, each persistent current loop in the plurality of persistent current loops of the arrangement 100 is coupled to a corresponding coupler in the plurality of couplers 1102.

In other embodiments, the plurality of persistent current loops may comprise a first and a second subset of persistent current loops. Each persistent current loop in the first subset may be coupled to a corresponding qubit in the plurality of qubits 1101 and each persistent current loop in the second subset may be coupled to a corresponding coupler in the plurality of couplers 1102.

According to an embodiment, each qubit in the plurality of qubits 1101 comprises at least one Josephson junction and/or each coupler in the plurality of couplers 1102 comprises at least one Josephson junction.

According to an embodiment, the plurality of qubits 1101 comprises superconductive qubits.

According to an embodiment, the quantum computing system further comprises a control unit 1103 coupled to the first plurality of signal lines and the second plurality of signal lines of the arrangement 100 and configured to shift a frequency of a target qubit in the plurality of qubits 1101 by providing a pulse to a signal line in the first plurality of signal lines corresponding to the target qubit and/or to a signal line in the second plurality of signal lines corresponding to the target qubit.

According to another embodiment, the control unit 1103 is configured to shift a frequency of a target qubit in the plurality of qubits 1101 by providing a pulse to a signal line corresponding to the target qubit in the first plurality of signal lines and allowing the current caused by the pulse to flow via a persistent current loop into a signal line corresponding to the target qubit in the second plurality of signal lines. This may be the case when the arrangement 100 is implemented in a fashion similar to, for example, the embodiment of FIG. 2.

According to another embodiment, the control unit 1103 is configured to shift a frequency of a target qubit in the plurality of qubits 1101 by providing a first pulse into a signal line corresponding to the target qubit in the first plurality of signal lines and a second pulse into a signal line corresponding to the target qubit in the second plurality of signal lines, wherein a total induced current by the first pulse and the second pulse in the target persistent current loop is greater than a critical current of the at least one Josephson junction of the target persistent current loop. This may be the case when the arrangement 100 is implemented in a fashion similar to, for example, the embodiment of FIG. 3.

When the system 1100 is operational, the arrangement 100 and/or the plurality of qubits 1101 may be physically located in a cryostat or similar. The cryostat may cool the arrangement 100 and/or the plurality of qubits 1101 to cryogenic temperatures. This may be required if the qubits in the plurality of qubits are, for example, superconductive qubits. The control unit 1103 may be located outside the cryostat.

Although the connection between the arrangement 100 and the control unit 1103 is schematically illustrated as a single connection in the embodiment of FIG. 11, the control unit 1103 may be electrically coupled to each signal line in the first plurality of signal lines and in the second plurality of signal lines.

FIG. 12 illustrates a schematic representation of a control unit according to an embodiment.

The control unit 1103 may comprise at least one processor 1201. The at least one processor 1201 may comprise, for example, one or more of various processing devices, such as a co-processor, a microprocessor, a control unit 1103, a digital signal processor (DSP), a processing circuitry with or without an accompanying DSP, or various other processing devices including integrated circuits such as, for example, an application specific integrated circuit (ASIC), a field programmable gate array (FPGA), a microprocessor unit (MCU), a hard-ware accelerator, a special-purpose computer chip, or the like.

The control unit 1103 may further comprise a memory 1202. The memory 1202 may be configured to store, for example, computer programs and the like. The memory 1202 may comprise one or more volatile memory devices, one or more non-volatile memory devices, and/or a combination of one or more volatile memory devices and non-volatile memory devices. For example, the memory 1202 may be embodied as magnetic storage devices (such as hard disk drives, floppy disks, magnetic tapes, etc.), optical magnetic storage devices, and semiconductor memories (such as mask ROM, PROM (programmable ROM), EPROM (erasable PROM), flash ROM, RAM (random access memory), etc.).

The control unit 1103 may further comprise other components not illustrated in the embodiment of FIG. 12. The control unit 1103 may comprise, for example, an input/output bus for connecting the control unit 1103 to the arrangement 100. Further, a user may control the control unit 1103 via the input/output bus. The control unit 1103 may further comprise means for providing the first/second pulse to the signal lines. For example, the control unit 1103 may comprise a DC source, such as a DC current source.

When the control unit 1103 is configured to implement some functionality, some component and/or components of the control unit 1103, such as the at least one processor 1201 and/or the memory 1202, may be configured to implement this functionality. Furthermore, when the at least one processor 1201 is configured to implement some functionality, this functionality may be implemented using program code comprised, for example, in the memory 1202.

The control unit 1103 may be implemented using, for example, a computer, some other computing device, or similar.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. An arrangement for quantum computing element frequency shifting, comprising:
a plurality of persistent current loops, each persistent current loop comprising at least one Josephson junction, at least one shunt resistive element, and at least one inductive element and each persistent current loop being couplable to a corresponding quantum computing element;
a first plurality of signal lines, wherein each persistent current loop in the plurality of persistent current loops is coupled to a corresponding signal line in the first plurality of signal lines; and
a second plurality of signal lines, wherein each persistent current loop in the plurality of persistent current loops is coupled to a corresponding signal line in the second plurality of signal lines;
wherein each persistent current loop in the plurality of persistent current loops is configured to induce a persistent current in the persistent current loop in response to a pulse in a corresponding signal line in the first plurality of signal lines and/or in a corresponding signal line in the second plurality of signal lines, wherein the persistent current is configured to cause a shift in a frequency of the corresponding quantum computing element.

2. The arrangement according to claim 1, wherein each persistent current loop in the plurality of persistent current loops is electrically coupled to the corresponding signal line in the first plurality of signal lines and to the corresponding signal line in the second plurality of signal lines, and is configured to induce the persistent current in the persistent current loop in response to an electrical current between the corresponding signal line in the first plurality of signal lines and the corresponding signal line in the second plurality of signal lines through the at least one Josephson junction exceeding a critical current of the at least one Josephson junction.

3. The arrangement according to claim 2, wherein each persistent current loop is electrically coupled to the corresponding signal line in the first plurality of signal lines via at least one first coupling resistive element and/or at least one first coupling inductive element and wherein each persistent current loop is coupled to the corresponding signal line in the second plurality of signal lines via at least one second coupling resistive element and/or at least one second coupling inductive element.

4. The arrangement according to claim 1, wherein each persistent current loop in the plurality of persistent current loops is inductively coupled to the corresponding signal line in the first plurality of signal lines and to the corresponding signal line in the second plurality of signal lines, and is configured to induce the persistent current in the persistent current loop in response to a first pulse in the corresponding signal line in the first plurality of signal lines and a second pulse in the corresponding signal line in the second plurality of signal lines when a total induced current by the first pulse and the second pulse in the persistent current loop is greater than a critical current of the at least one Josephson junction of the persistent current loop.

5. The arrangement according to claim 1, wherein each persistent current loop in the plurality of persistent current loops is inductively couplable to the corresponding quantum computing element and is configured to cause the shift in the frequency of the corresponding quantum computing element via a magnetic field induced by the persistent current.

6. The arrangement according to claim 5, wherein each quantum computing element comprises at least one Josephson junction, and wherein the magnetic field is configured to adjust a Josephson inductance of the at least one Josephson junction of the corresponding quantum computing element.

7. The arrangement according to claim 1, wherein each quantum computing element comprises a qubit or a coupler between qubits.

8. A quantum computing system comprising a plurality of qubits and an arrangement according to claim 1, wherein at least one persistent current loop in the plurality of persistent current loops of the arrangement is coupled to a corresponding qubit in the plurality of qubits.

9. The quantum computing system according to claim 8 further comprising a plurality of couplers, wherein each coupler is coupled to two qubits in the plurality of qubits and configured to control coupling between the two qubits, and wherein at least one persistent current loop in the plurality of persistent current loops of the arrangement is coupled to a corresponding coupler in the plurality of couplers.

10. The quantum computing system according to claim 8, wherein each qubit in the plurality of qubits comprises at least one Josephson junction.

11. The quantum computing system according to claim 8, wherein the plurality of qubits comprises superconductive qubits.

12. The quantum computing system according to claim 8 further comprising a control unit coupled to the first plurality of signal lines and the second plurality of signal lines of the arrangement and configured to shift a frequency of a target qubit in the plurality of qubits by providing a pulse to a signal line in the first plurality of signal lines corresponding to the target qubit and/or to a signal line in the second plurality of signal lines corresponding to the target qubit.

13. The quantum computing system according to claim 9, wherein each coupler in the plurality of couplers comprises at least one Josephson junction.
